(19) United States
(12) Patent Application Publication
(10) Pub. No.: US 2023/0316252 A1
(43) Pub. Date: Oct. 5, 2023

(54) SYSTEM AND METHODS ASSOCIATED WITH RETAIL MACHINE CONFIGURATION UTILIZING MULTIPLE TYPES COMMUNICATION NETWORKS

(71) Applicant: Katzenfreunde LLC, Austin, TX (US)

(72) Inventor: Thilo Suelberg, Austin, TX (US)

(73) Assignee: Katzenfreunde LLC, Lakeway, TX (US)

(21) Appl. No.: 18/128,332

(22) Filed: Mar. 30, 2023

Related U.S. Application Data
(60) Provisional application No. 63/327,587, filed on Apr. 5, 2022.

(51) Int. Cl. G06Q 20/20; G06Q 20/18

(52) U.S. Cl. CPC G06Q 20/203; G06Q 20/18

(57) ABSTRACT

A user computing device configured to receive update configurations from a back-end server over a second network responsive to the user computing device making a selection request associated with a retail machine over a first network, and the user computing device receiving confirmation data indicating configurations of the retail machine have changed from the retail machine over the first network, and the user computing device transmitting the confirmation data to the backend server over the second network.

### TECHNICAL FIELD

Embodiments disclose systems and methods associated with retail machine telemetry, replenishment, and configuration utilizing multiple types of communication networks. Specifically, embodiments are directed towards utilizing a user computing device configured to receive configuration updates from a back-end server over a second network responsive to the user computing device making a selection request associated with a retail machine over a first network, and the user computing device receiving confirmation data indicating configurations of the retail machine have changed from the retail machine over the first network, and the user computing device transmitting the confirmation data to the backend server over the second network.

### BACKGROUND

A retail machine is a device that sells and dispenses various items, such as food, drinks, or other items including newspapers, cigarettes, electronics, etc. Retail machines, such as vending machines, are widely used to sell products outside a store, in remote locations, or during off-hours.

To dispense items, retail machines require frequent replenishment and configuration updates, such as item pricing. This is particularly necessary in the food and beverage industry where most products have an expiration date. Due to the expiration of products stored and sold via the retail machine, it is important to know the refill quantity and next refill date.

Currently, to reconfigure an unattended retail machine, a service technician or replenishment driver needs to be present at the retail machine and carry out the necessary steps. This requires specialized knowledge about the specific machine and configuration details. Alternatively, a telemetry device installed in the retail machine may be used to update the configuration remotely. However, those telemetry devices require a data connection to a backend system, such as a cellular network, which cost money.

Accordingly, needs exist for systems and methods utilizing dual pathways to communicate configuration data from a backend to an unattended retail machine, wherein the dual pathways reduce the costs associated with data transfers. The device disclosed here uses a customer's mobile computing device to relay configuration changes responsive to a transaction.

### SUMMARY

Embodiments described herein relate to universal retail machine systems and methods that are configured to relay configuration data from a backend server over multiple pathways and/or networks. In embodiments, an unattended retail device may be installed within a retail machine, and/or be communicatively coupled with a retail machine bus or controller. The unattended retail device may be configured to receive data and transmit data to a backend server by relaying such data through user computing devices responsive to a user performing actions to complete a transaction with the retail machine, which may be completed without the unattended retail device ever directly communicating with the backend server.

Embodiments may include an operator computer device, backend server, retail machine with an unattended retail device, and a user computing device.

The operator computing device may be a device associated with an operator of the retail machine, who may be instructed to provide configuration updates to the retail machine and/or unattended retail device (referred to hereinafter collectively or individually as “retail machine”). The configuration updates may include inventory data, sales data, pricing data, space-to-sales data, restocking data, cash data, coin data, etc. The operating computing device may be configured to directly communicate with the backend server over a second type of network.

The retail machine with the unattended retail device may be a vending machine configured to dispense a plurality of consumer goods. The retail machine may be configured to produce and transmit data associated with the status of the retail machine, such as sales, technical issues, or out-of-stock situations. In embodiments, the retail machine may not be able to communicate data over the second type of network, and may relay data to the backend server via the user computing device over a first type of network. The unattended retail device may be configured to collect and transmit data over the first network to the user computing device, and receive configuration commands over the first network from the user computing device. In embodiments, the unattended retail device may be configured to relay data through the user computing device responsive to the user performing actions to complete or attempting a transaction with the retail machine using the user computing device, wherein a user interface on the user interface may be utilized to make a selection of items stored within the retail machine.

Responsive to receiving the configuration commands from the user computing device, the retail machine may instruct the unattended retail device to dispense an item, and apply configuration changes. Furthermore, upon the unattended retail device applying the configuration changes, the retail machine may transmit data indicating the configuration changes have been updated to a user computing device over the first network. This data may be relayed as part of the next transaction if the configuration changes cannot be applied right away.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions, or rearrangements may be made within the scope of the invention. The invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a perspective view of a topology utilizing a retail machine device, according to an embodiment.

FIG. 2 depicts a retail machine device, according to an embodiment.

FIG. 3 depicts a user computing device, according to an embodiment.

FIG. 4 depicts a method for an operator computing device transmitting updated configuration settings for a vending machine, according to an embodiment.

FIG. 5 depicts a method for user computer device receiving updated configuration settings for a retail machine over a first network, and transmitting the received updated configured settings for the vending machine over a second network, according to an embodiment.

FIG. 6 illustrates a method for a retail machine updating its configuration settings, according to an embodiment.

FIG. 7 illustrates a timing diagram for a retail machine updating its configuration settings, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

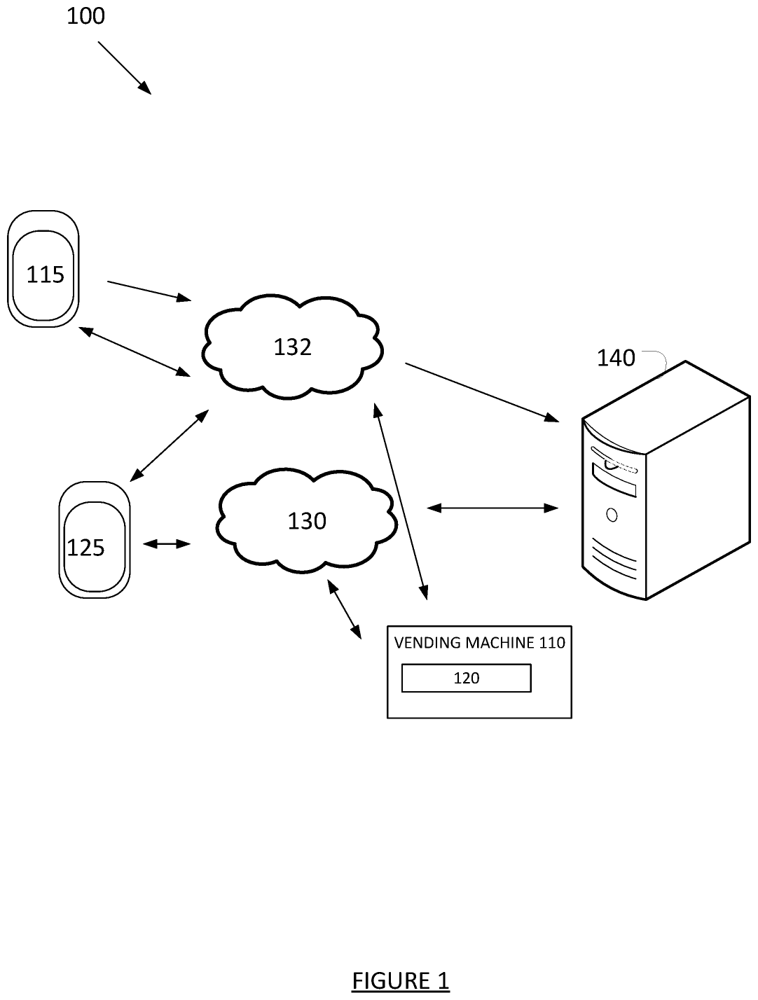

FIG. 1 depicts a perspective view of a topology 100, according to an embodiment. Topology 100 may include a retail machine 110, an operator computing device 115, user computing device 125, networks 130 and 132, and backend server 140.

Retail machine 110 may be a device that is configured to dispense items such as snacks, beverages, consumers goods, newspapers, alcohol, cigarettes, electronics, etc. Retail machine 110 may include a selection interface where a user may perform commands to select a specific item to be dispensed from the retail machine 110, a money input where a user may insert money for the selected item, a dispenser configured to dispense the selected item, and a change return mechanism configured to return change to the user.

Retail machine 110 may also include a computer with a processor. The computer may include a computer bus and/or a digital data interface. The computer bus may be configured to connect the components of retail machine 110 to an electrical circuit. Furthermore, the computer bus may be configured to interface different payment systems of retail machine 110, such as a cashless payment terminal or a coin changer. The digital data interface may be configured to provide audit capabilities of retail machine 110, which audit the inventory and status information of retail machine 110. The digital exchange may be configured to determine and communicate data such as sales, cash, coins, sales of units by selection, pricing, door openings, etc. In embodiments, the computer bus and the digital exchange may be configured to determine sales data and configuration data associated with the retail machine 110.

Retail machine 110 may include an unattended retail device 120 that is configured to connect to the computer bus and/or the digital data interface. In embodiments, the unattended retail device 120 may manage the configuration data utilized to set the space-to-sales mapping, price data, and other functionalities of retail machine 110. In embodiments, retail machine 110 and unattended retail device 120 may only be able to configured to communicate data over network 130, and may not be able to communication data over any other type of network, such as network 132. This may cause retail machine 110 to only be able to communicate with devices in close proximity to retail machine 110.

Operator computing device 115 may be any type of mobile device with a hardware processor that is configured to process instructions and connect to backend server 140 over network 132. Operator computing device 115 may be configured to transmit configuration data to backend server 140 or change configuration data stored on backend server 140, which can be later be relayed to unattended retail device 120 via user computing device 125. In embodiments, the configuration data may include inventory data, sales data, pricing data, space-to-sales data, restocking data, cash data, coin data, etc. In further implementations, operator computing device 115 may be configured to directly update configuration data on unattended retail device 120 over network 130.

User computing device 125 may be any type of mobile device with a hardware processor that is configured to process instructions and connect to unattended retail device 120 over networks 130, 132 or more portions of networks 130, 132. Additionally, user computing device 125 may be configured to communicate with backend server 140 over network 132. User computing device 125 may be utilized by a user to purchase goods sold by retail machine 110.

Responsive to the user making a selection on a user interface of user computing device 125 associated with retail machine 110 or directly on a graphical user interface of retail machine 110, user computing device 125 may transit data, such as a preauthorization request for a sale, to backend server 140 associated with the selection, and in return may receive pending configuration requests for the vending machine 110 over network 132. Upon receiving the pending configuration requests for the vending machine 110 from backend server 140 over network 132, user computing device 125 may transmit data associated with the transaction and the configuration updates to vending machine 110 over network 130.

After the transaction is completed, user computing device 125 may be configured to receive data associated with the transaction, such as inventory data and pricing data, from vending machine 110 over network 130. Additionally, user computing device 125 may include data indicating that the pending or a previous configuration request for vending machine 110 has been changed from vending machine 120. Subsequently, user computing device 125 may transmit the data indicating that the pending or previous configuration for vending machine 110 has been updated to backend server 140 over network 132.

Backend server 140 may be a computer server or any other type of device with a hardware processor configured to process instructions and connect to network 132 or one or more portions of networks 132. Backend server 140 may be positioned in a remote location from retail machine 110. Backend server 140 may be configured to receive and/or transmit information associated with an inventory of the retail machine 110, pricing of items carried by retail machine 110, business rules associated with retail machine 110, configurations associated with retail machine 110, sales data associated with retail machine 110, etc. over network 132. Utilizing backend server 140, an operator may be able to indirectly and remotely configure retail machine 110, while also viewing sales data associated with retail machine 110. Specifically, utilizing backend server 140, the operator may be able to change the configuration settings on retail machine 110 without ever communicating with the only network 130, which retail machine 110 may be coupled to, by relaying data through a user computing device 125.

Network 130 may be a first type of network. For example, network 130 may be a wireless local area network (WLAN, Wi-Fi), Bluetooth, NFC, LoRa, ZigBee or local area network (LAN) that is configured to link two or more devices within a limited area. Network 130 may be configured to allow for data transmission over a closed loop network by users with network credentials. It will be understood that network 130 may be a combination of multiple different kinds of wired or wireless networks operating over a second network protocol.

Network 132 may be a second type of network. Network 132 may be a wide area network (WAN) that extends over a large geographical distance. First type of network 132 may be a wireless communications network, digital radio, or cellular network operating over 5G, 4G, LTE, CDMA, GSM, etc. Network 132 may be operated by telecommunications providers. However, transmitting data over first type of Network 132 may have a higher cost associated with transmitting data than Network 130. It will be understood that network 132 may be a combination of multiple different kinds of wired or wireless networks operating over a first network protocol. In embodiments, network 130 may have a lower cost associated with transmitting data than network 132, and network 132 may be able to communicate data at higher speeds and with more bandwidth than network 130.

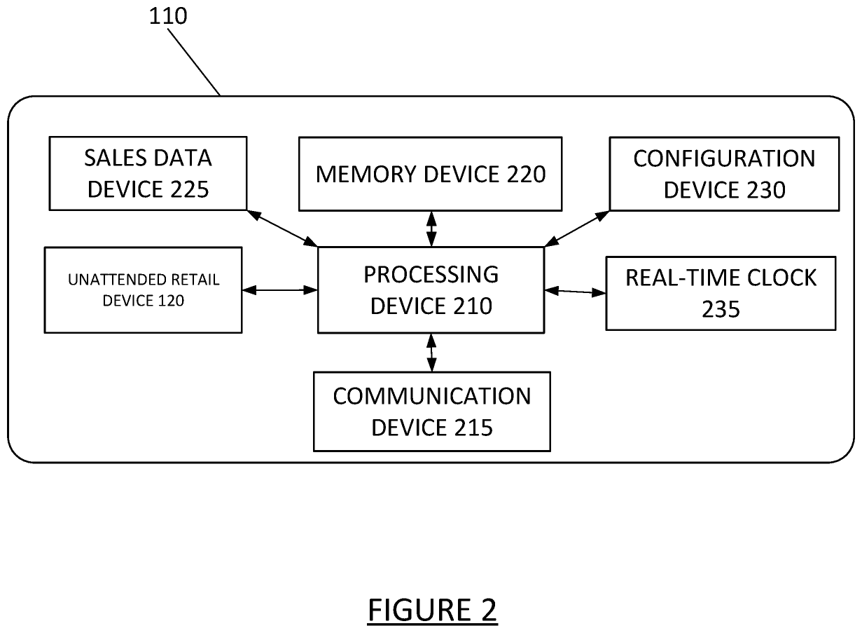

FIG. 2 depicts a vending machine 110 utilizing an unattended retail device 120, according to an embodiment. Unattended retail device 120 may be configured to transmit and receive data over network 130 to and from user computing device 125, wherein this data is utilized to update configuration settings. Additionally, unattended retail device 120 may be configured to communicate data over network 130 to user computing device 125, wherein the data is an indicator indicating that the received configuration settings associated with the first data have been updated. In embodiments, this data may be automatically relayed over network 132 to backend server 140 via user computing device 125.

Unattended retail device 120 may be a computing device that is configured to couple with computing devices of retail machine 110 and user computing device 125 over network 130. Unattended retail device 120 may include or be communicatively coupled with a processing device 210, communication device 215, memory device 220, sales data device 225, a configuration device 230, and real-time clock 235.

The processing device 210 can include memory, e.g., read only memory (ROM) and random-access memory (RAM), storing processor-executable instructions and one or more processors that execute the processor-executable instructions. In embodiments where the processing device 210 includes two or more processors, the processors may operate in a parallel or distributed manner. The processing device 210 may execute an operating system of unattended retail device 120 or software associated with other elements of consumer unattended retail device 120.

The communications device 215 may be a device that allows unattended retail device 120 and/or vending machine 110 to communicate with another device, e.g., an operator computing device 115 or user computing device 125. The communications device 215 may include one or more wireless transceivers for performing wireless communication and/or one or more communication ports for performing wired communication. The communication device 215 may have a first network interface and a second network interface. The first network interface may be configured to communication with external devices, such as a replenishment driver computing device 140, and the second network interface may be configured to communicate with internal devices, such as computing elements of retail machine 110. The first network interface may include a USB port, Wi-Fi, NFC, Ethernet port, Bluetooth, etc. that communicate over network 130, etc. The second type of network may be a wired network connection with the bus and digital exchange of retail machine 110.

The memory device 220 may be a device that stores data generated or received by unattended retail device 120. The memory device may include, but is not limited to a hard disc drive, an optical disc drive, EEPROM and/or a flash memory drive. In embodiments, the memory device 220 may be configured to store information received from the computing devices associated with the unattended retail device 120 and/or vending machine 110, such as various configuration settings, inventory data, and a unique identifier associated with the unattended retail device 120. In embodiments, the configuration settings may include data indicating when the configurations for unattended retail device 120 were last updated, update number, audit data, sales data, pricing data, etc.

The sales data device 225 may be configured to receive sales data from the unattended retail device 120 and/or vending machine 110. The sales data may include data associated with what items were sold by unattended retail device 120 and/or vending machine 110 and at what time and price point. Furthermore, the sales data may also include data indicating a current stock level of each item stored within unattended retail device 120 and/or vending machine 110 and a maximum allowable stock carried for each item stored within retail machine 110. In embodiments, the sales data device 225 may be configured to transmit the sales data to backend server 140 via user computing device 125.

The configuration data device 230 may be configured to receive data associated with configurations of unattended retail device 120. The configuration data device 230 may be configured to receive configuration data from a user computing device 125 over first network 130, and transmit configuration change results to the user computing device 125 over first network 130. These configurations may include data associated with sale prices for various items stored within unattended retail device 120, technical data associated with unattended retail device 120, business rules for unattended retail device 120, such as at what price point and when items should be sold by unattended retail device 120, or any other data that may be utilized to unattended retail device 120.

In embodiments, the configuration data device 230 may be utilized to configure the settings, price data, and other functionalities of unattended retail device 120. Responsive to receiving the configuration commands indirectly from backend server 140, the configuration data device 230 may control the unattended retail device 120 to optimize the retail machine 110. For example, the configuration data device 230 may be configured to receive pricing data to dynamically determine or change pricing rules for the retail machine 110 based on business rules. Therefore, an owner of the retail machine 110 may change configurations associated with the retail machine, such as a column or selector layout, product pricing, or consignment setting via the text message without having to visit the retail machine 110 or directly communicate any data with a network that that retail machine 110 is coupled with.

In embodiments, the real time clock device 235 may be utilized to provide accurate timestamps used by other components of the system. Real time clock device 235 may be configured to generate a timestamp upon completing a transaction and/or updating the configuration settings, wherein the timestamp is a sequence of characters or encoded information identifying when a certain event occurred. Another timestamp may be generated by real time clock device 235 responsive to unattended retail device 120 transmitting or receiving data over first network 130. This may be advantageous due to the possibility that retail machine 110 may be offline and not be able to immediately communicate data.

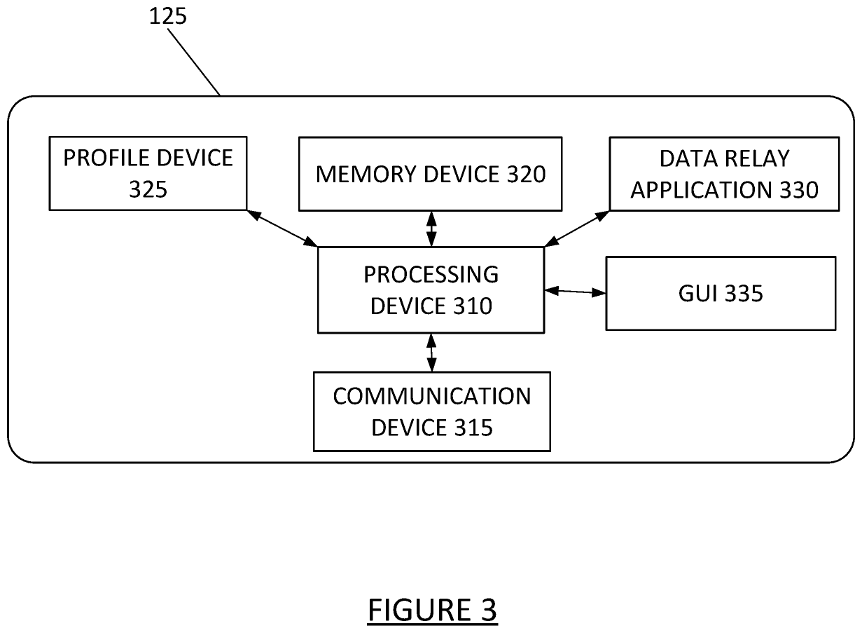

FIG. 3 depict user computing device 125, according to an embodiment. User computing device 125 may include a processing device 310, communication devices 315, memory device 320, profile device 325, data relay application 330, and graphical user interface 335.

Processing device 310 may include memory, e.g., read only memory (ROM) and random-access memory (RAM), storing processor-executable instructions and one or more processors that execute the processor-executable instructions. Processing device 310 may be configured to execute an operating system of user computing device 125. In embodiments where processing device 310 includes two or more processors, the processors may operate in a parallel or distributed manner.

Communication device 315 may be a device that allows user computing device 125 to communicate with another device over a wireless or wired network over networks 130, 132. Communication device 315 may include one or more wireless transceivers for performing wireless communication and/or one or more communication ports for performing wired communication. Communication device 315 may be configured to communicate data over a plurality of different standard and/or protocols.

Profile module device 325 may be a hardware processing device configured to create a profile for the user. The user's profiles may include for example, information identifying users (e.g., a username or handle, a number, an identifier, and/or other identifying information), security login information (e.g., a login code or password), payment information (e.g., credit card information), purchase history, etc.

Data Relay Application 330 may be a mobile application that allows a user to purchase goods sold or carried by retail machine 110 and receive data from unattended retail device 120 and/or retail machine 110. Data relay application 330 may be able to store a pre-paid balance associated with the user's payment information, and utilizing an input from the user on GUI 335, data relay application 330 may transmit data associated with the user's current available balance to retail machine 110. When retail machine 110 receives the data from data relay application 330, retail machine 110 may instruct operations to enable the selection of goods. For example, a user may perform actions to select an item to purchase on a graphical user interface on retail machine 110. In embodiments, data relay application 330 may be a mobile application stored on user computing device 125 that allows direct communication with various retail machines 110.

In embodiments, responsive to user computing device 125 being in close proximity to retail machine 110, data relay application 330 may receive a unique identification from unattended retail device 120 over network 130. In embodiments, data relay application 330 may determine it is in close proximity to unattended retail device 120 via various manners, such as geo-fences, determining user computing device 125 is capable of connecting to a same network as unattended retail device 120. Responsive to receiving the unique identifier, data relay application 330 may transmit the unique identifier to backend server 140 over network 132. Subsequently, data relay application 330 may receive configuration data such as products, button assignments, inventory, and pricing that can be presented on GUI 335, which can be utilized to make a selection.

Responsive to the user selecting an item on the graphical user interface of vending machine 110 or data relay application 330, data relay application 330 may be pre-authorized for a transaction utilizing money or points via back-end server 140 and establish a secure connection with unattended retail device 120. After making the secure connection, user computing device 125 may utilize the unique identifier associated with unattended retail device 120 for backend server 140 to determine if any configuration change requests are pending on backend server 140 for unattended retail device 120 and/or retail machine 110. If there are configuration change requests pending, backend server 140 may transmit the new configuration change requests to data relay application 330 before retail machine 110 completes the transaction or dispenses the product associated with the transaction.

After selecting the item and receiving the new configuration change request data, retail machine 110 may receive data associated with the selected item. Utilizing the data associated with the selected item, retail machine 110 may dispense the item and complete the transaction. Additionally, unattended retail device 120 may transmit data to data relay application 330 associated with the last configuration settings that occurred before data relay application 330 initiated its transaction with unattended retail device 120 or data relay application 330 received the new configuration settings, which may have been received from another user computing device completing a transaction previously. The last configuration settings may indicate that the configuration settings of unattended retail device 120 and/or retail machine 110 were changed prior to the transaction, which may include a time stamp, update number, inventory data, etc.

After the transaction is completed, data relay application 330 may transmit the new configuration settings to retail machine 110 over network 130 to update the configuration settings. These changes may be communicated to backend server 140 responsive to a subsequent transaction by the same or different user computing device with retail machine 110. This may allow unattended retail machine 110 to update its configuration settings after dispensing a product to not slow down the current transaction.

Additionally, unattended retail device 120 and/or retail machine 110 may perform actions to update its configurations setting based on the configuration change request data. After receiving the updating configuration settings, which may allow unattended retail device 120 and/or retail machine 110 to update its setting when not connected to user computer device 125 and not connected to devices over network 130.

In embodiments, it may be required for unattended retail device 120 and/or retail machine 110 to update its configurations, such as pricing and button mapping, after the transaction with user computing device 125. As a result of updating its configurations, unattended retail device 120 and/or retail machine 110 may restart. This restart may sever the connection between user computing device and retail machine 110. Additionally, it may take a decent amount of time to perform the configuration settings update, transaction, and confirmation of the updated settings in a single transaction. this restart. For these reasons, unattended retail device 120 and/or retail machine 110 may update its configuration settings and transmit the data indicating that the configuration has changed to a second user computing device after a subsequent transaction.

In alternative embodiments, after selecting the item and receiving the new configuration change request data from backend server 140, data relay application 330 may communicate the new configuration settings to retail machine 110 along with the data associated with the selected item. Utilizing the data associated with the selected item, retail machine 110 may dispense the item and complete the transaction. Additionally, unattended retail device 120 may transmit data to data relay application 330 associated with the new configuration settings that the new configuration settings have been updated. The data may indicate the unattended retail device 120 and/or retail machine 110 configuration settings have changed, which may include a time stamp, update number, inventory data, etc. In embodiments, unattended retail device 120 may update its configuration settings with the new configuration settings and transmit data to user computing device 125 indicating that the configuration changes have changed, while performing a same transaction with user computing device 125.

After receiving the configuration settings change data from unattended retail device 120 over network 130, user computing device 125 may relay the configuration settings change data to backend server 140 over network 132. This may allow unattended retail device 120 to report its configuration settings more quickly.

GUI 335 may be a device that allows a user to interact with user computing device 125. While one GUI 335 is shown, the term “user interface” may include, but is not limited to being, a touch screen, a physical keyboard, a mouse, a camera, a video camera, glasses presenting augmented reality to the consumer, a microphone, and/or a speaker. GUI 335 may include inputs where the user may complete a wireless transaction with goods with retail machine 110.

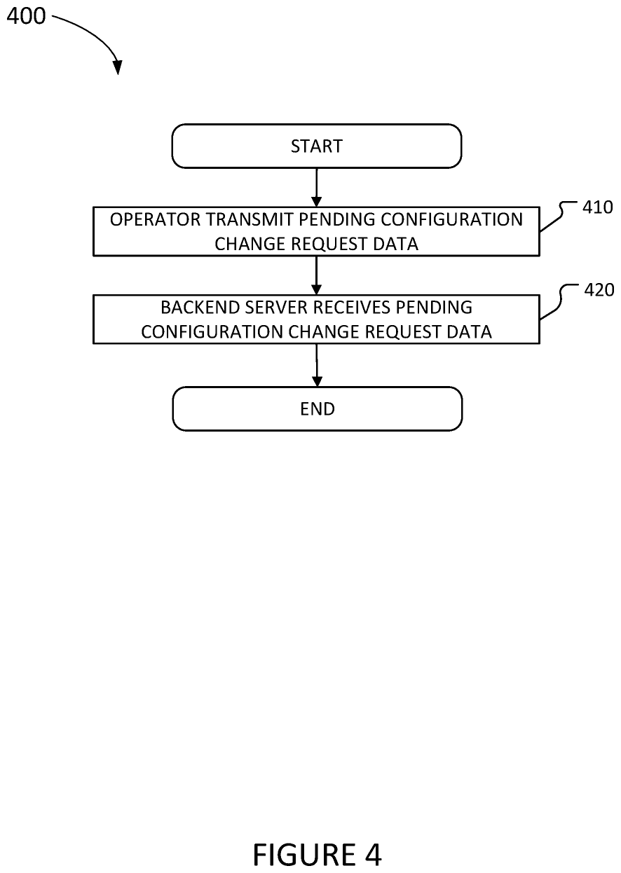

FIG. 4 illustrates a method 400 for an operator computing device 115 communicating with a backend server 140 over a first network. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At operation 410, an operator may transmit pending configuration change request data to a backend server. The pending configuration change request data may include a unique identifier associated with a vending machine and be configurated to change the configuration settings of an unattended retail machine. In embodiments, the configuration settings may include pricing data, inventory data, etc. In alternative embodiments, the operator may interact directly with the server, such as on a web browser on the operator device accessing a webpage associated with the server.

At operation 420, a backend server may load the pending configuration change request data along with the unique identifier into a memory associated with the backend server.

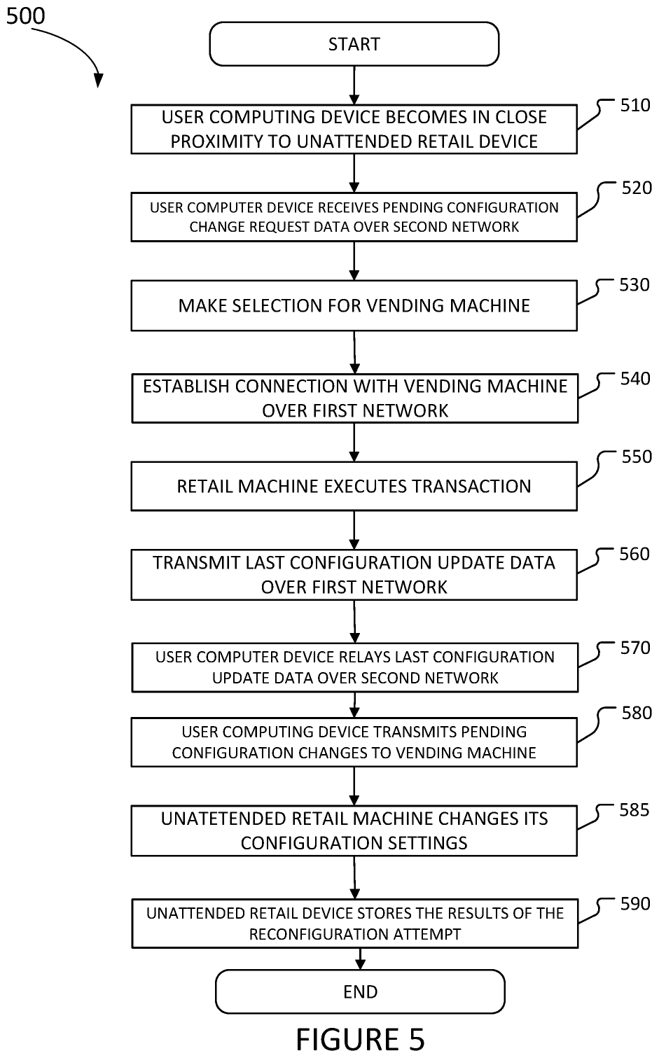

FIG. 5 illustrates a method 500 for a user computing device 125 communicating with a backend server 140 over network 132 and a vending machine 110 over network 130, according to embodiments. By relaying data over different networks, user computing device 125 may reduce costs by reducing the amount of data transmitted via vending machine 110. Furthermore, by relaying data over the different networks, the backend server may indirectly receive data from the retail machine at various times, which may reduce the likelihood that the retail machine is underserviced.

The operations of method 500 presented below are intended to be illustrative. In some embodiments, method 500 may be accomplished with one or more additional operations not described, and/or without one or more of the operations discussed. Additionally, the order in which the operations of method 500 are illustrated in FIG. 5 and described below is not intended to be limiting.

In some embodiments, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

At operation 510, a user computing device may become in close proximity to an unattended retail device associated with the vending machine, and receive a unique identifier associate with the unattended retail device over a first network.

At operation 520, responsive to receiving the unique identifier associated with the unattended retail device, the user computing device may transmit the unique identifier to the backend server, and in return receive the pending configuration change request data over a second network.

At operation 530, a graphical user interface associated with the user computing device may be presented to the user, and the user may utilize the graphical user interface to make a selection of an item associated with the vending machine. The selection may include an item and a price.

At operation 540, the user may be pre-authorized for the selection, and establish a secure connection with the unattended retail device over the first network. In embodiments, data associated with the selection may be transmitted to the retail machine.

At operation 550, the retail machine may execute the transaction and the unattended retail device may dispense the product associated with the selection data may be dispensed.

At operation 560, the transaction may be completed, and the unattended retail device may transmit last configuration update data to the user computer device associated with the last configuration settings updated by the unattended retail device before operation 510 over the first network. In implementations, the last configuration update data may include configuration changes, inventory changes, pricing updates, and/or a timestamp.

At operation 570, the user computer device may transmit the last configuration update data to the backend server over the second network.

At operation 580, the user computer device transmits the pending configuration changes received from the backend server in operation 520 over the first network to the unattended retail device.

At operation 585, the unattended retail machine may change its configuration settings based on the pending configuration change request data.

At operation 590, the unattended retail device may store the results of the reconfiguration attempt. For example, the unattended retail device may store the results as successful or unsuccessful along with a timestamp. This data may be later transmitted to the user computing device or another user computing device responsive to a user computer device establishing a connection.

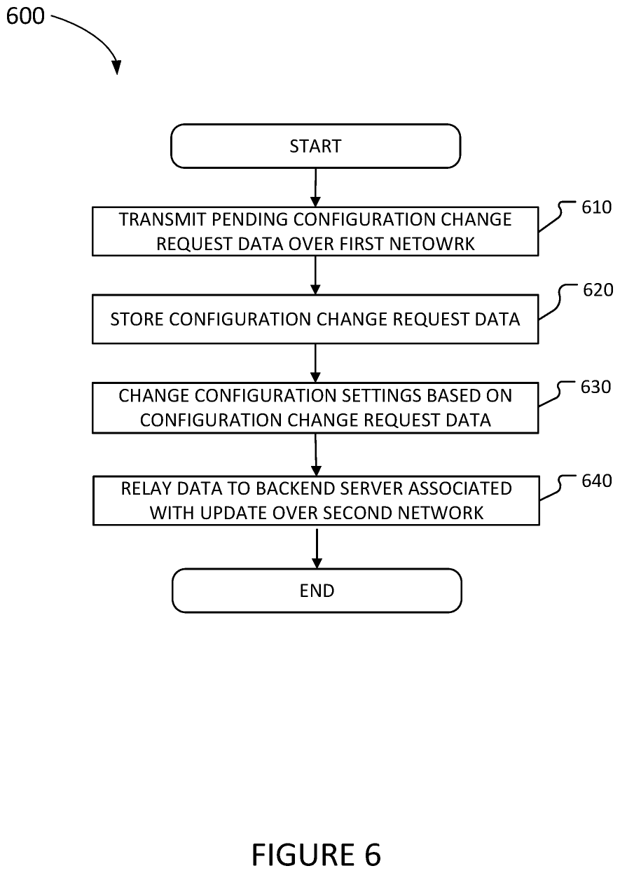

FIG. 6 illustrates a method 600 for a user computing device to update settings of a retail machine, according to embodiments. The operations of method 600 presented below are intended to be illustrative. In some embodiments, method 600 may be accomplished with one or more additional operations not described, and/or without one or more of the operations discussed. Additionally, the order in which the operations of method 600 are illustrated in FIG. 6 and described below is not intended to be limiting.

At operation 610, after a product has been dispensed, a transaction has been completed by a vending machine, and the user computer device has transmitted the last configuration update data to the backend server over the second network, the user computing device may transmit the pending configuration change request data to the unattended retail machine through the vending machine over the first network.

At operation 620, the vending machine may store the pending configuration change request data within a queue.

At operation 630, the unattended retail machine may change its settings based on the pending configuration change request data.

At operation 640, the unattended retail machine may and transmit data to the vending machine indicated that its configurations have been changed, wherein this data can be forwarded to the backend server responsive to a subsequent transaction being completed on the vending machine.

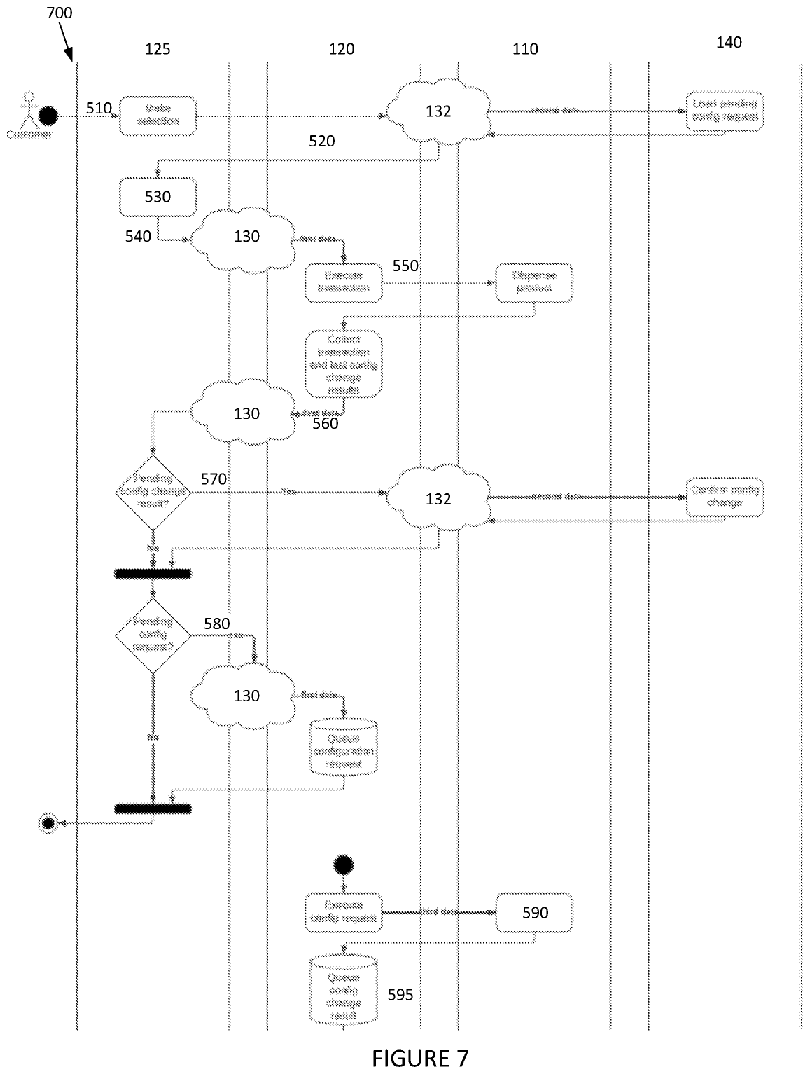

FIG. 7 illustrates a timing diagram associated with methods 400, 500, 600, according to embodiments. Elements depicted in FIG. 7 may be described above, and for the sake of brevity a further description of these elements may be omitted.

In the foregoing specification, embodiments have been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of the invention.

Although the invention has been described with respect to specific embodiments thereof, these embodiments are merely illustrative, and are thus not restrictive of the invention. The description herein of illustrated embodiments of the invention is not intended to be exhaustive or to limit the invention to the precise forms disclosed herein (in particular, the inclusion of any particular embodiment, feature, or function is not intended to limit the scope of the invention to such embodiment, feature, or function).

Rather, the description is intended to describe illustrative embodiments, features and functions in order to provide a person of ordinary skill in the art context to understand the invention without limiting the invention to any particularly described embodiment, feature, or function. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes, and substitutions are intended in the foregoing disclosures. It will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment,” “an embodiment,” “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment.

Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

Furthermore, the term “or” as used herein is generally intended to mean “and/or” unless otherwise indicated. As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein, the meaning of “in” includes “in” and “on” unless the context clearly dictates otherwise.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed:

1. A retail machine system comprising:
a vending device with configuration settings, the vending device being configured to receive pending configuration settings over a first network;
a backend server configured to transmit the pending configuration settings for the vending device over a second network, wherein the vending device is configured to receive the pending configuration settings responsive to receiving a first transaction request.

2. The retail machine system of claim 1, wherein the vending device is configured to receive the pending configuration settings after completing a first transaction associated with the first transaction request.

3. The retail machine system of claim 2, wherein the first transaction is completed after a selected item has been dispensed.

4. The retail machine system of claim 1, wherein the vending device is configured to transmit data indicating the configuration settings of the vending device based on the pending configuration settings have changed over the first network responsive to completing a second transaction.

5. The retail machine system of claim 4, further comprising:
a first computing device configured to receive the pending configuration settings over the second network, and transmit the pending configuration settings over the first network and transmit the first transaction request.

6. The retail machine system of claim 5, further comprising:
a second computing device configured to receive the data indicating the configurations of the vending device have changed based on the pending configuration settings.

7. The retail machine system of claim 6, wherein the vending device is configured to receive a second transaction request from the second computing device.

8. The retail machine system of claim 6, wherein the second computing device is configured to transmit the data indicating the configurations of the vending device have changed based on the pending configuration settings over the second network to the backend server.

9. The retail machine system of claim 5, wherein the vending device updates the configuration settings while the vending device is not connected to any device over the first network.

10. The retail machine system of claim, wherein the vending device is not configured to communicate over the second network.
